(19) United States
(12) Patent Application Publication
(10) Pub. No.: US 2004/0209581 A1
(43) Pub. Date: Oct. 21, 2004

(54) Dual-mode bandpass filter, duplexer, and radio communication apparatus

(75) Inventors: Naoki Mizoguchi, Moriyama-shi (JP); Hisatake Okamura, Nagaokakyo-shi (JP)

Correspondence Address: Keating & Bennett LLP, Suite 312, 10400 Eaton Place, Fairfax, VA, 22030, US

(73) Assignee: Murata Manufacturing Co., Ltd., Nagaokakyo-shi (JP)

(21) Appl. No.: 10/775,138

(22) Filed: Feb. 11, 2004

(30) Foreign Application Priority Data
Apr. 15, 2003 (JP) 2003-110535

(51) Int. Cl. H04Q 7/20

(52) U.S. Cl. 455/127.4

(57) ABSTRACT

A dual-mode bandpass filter includes a dielectric substrate, a resonator electrode disposed at a certain height in the dielectric substrate, and a ground electrode disposed at a different height in the dielectric substrate from the resonator electrode so as to oppose the resonator electrode. The ground electrode has a opening, whereby a resonant electric field of the resonator electrode is controlled to couple two resonant modes generated in the resonator electrode.

### BACKGROUND OF THE INVENTION

1. Field of the Invention

The present invention relates to a dual-mode bandpass filter serving as a band filter for use in, for example, microwave band to millimeter-wave band communication systems, a duplexer using the dual-mode bandpass filter, and a radio communication apparatus.

2. Description of the Related Art

A variety of dual-mode bandpass filters serving as bandpass filters used in a high-frequency region have been proposed. One of such dual-mode bandpass filters is described in, for example, J. A. Curtis and S. J. Fiedziuszko, “Miniature Dual Mode Microstrip Filters,” IEEE MTT-S Digest, 1991.

In the dual-mode bandpass filter described in this publication, an input line and an output line are coupled with a resonator electrode, and are arranged so that the central angle between the input line and the output line is 90° with respect to the center of a circular resonator pattern, and an open-end stripline stub is provided at a central angle of 135° from the input and output lines for coupling two resonant modes.

The publication also discloses a structure in which input and output lines are coupled at the center portions of two adjacent sides of a square resonator pattern, and a corner facing the corner disposed by the two adjacent sides is cut out, so that two resonant modes are coupled.

In the dual-mode bandpass filter described in this publication, however, the two resonant modes are not sufficiently coupled, thus making it difficult to increase the transmission bandwidth. Moreover, the shape of the resonator pattern is limited, resulting in low design flexibility.

### SUMMARY OF THE INVENTION

In order to overcome the problems described above, preferred embodiments of the present invention provide a dual-mode bandpass filter having high flexibility in design and achieving a desired bandwidth with ease.

In a preferred embodiment of the present invention, a dual-mode band-pass filter includes a dielectric substrate, a resonator electrode disposed at a certain height in the dielectric substrate, and a ground electrode disposed at a different height in the dielectric substrate from the resonator electrode so as to oppose the resonator electrode. The ground electrode includes at least one opening, whereby a resonant electric field of the resonator electrode is controlled to couple two resonant modes generated in the resonator electrode.

In a specific preferred embodiment of the dual-mode band-pass filter of the present invention, the opening may be disposed at a position substantially opposing the resonator electrode.

In another specific preferred embodiment of the dual-mode band-pass filter of the present invention, the ground electrode may be embedded in the dielectric substrate.

In a further specific preferred embodiment of the dual-mode band-pass filter of the present invention, the dual-mode band-pass filter may further include a second ground electrode disposed on the dielectric substrate at the ground electrode side opposite to the resonator electrode, a third ground electrode disposed on the dielectric substrate at the resonator electrode side opposite to the ground electrode.

In another specific preferred embodiment of the dual-mode band-pass filter of the present invention, the second ground electrode may be disposed on the top surface of the dielectric substrate, and the third ground electrode may be disposed on the rear surface of the dielectric substrate. Therefore, the second and third ground electrodes can be easily formed and positioned as desired.

In a specific preferred embodiment of the dual-mode band-pass filter of the present invention, the ground electrode may include a plurality of openings. The number of openings, the position of the openings, etc., can be adjusted to control the characteristic of the dual-mode band-pass filter with ease.

In a specific preferred embodiment of the dual-mode band-pass filter of the present invention, each opening has a rectangular, circular, rhombic, or polygonal shape in plan view. However, the shape of each opening is not limited thereto, and the shape of each opening can be modified to modify the specification of the dual-mode band-pass filter with ease.

In a specific preferred embodiment of the dual-mode band-pass filter of the present invention, the dual-mode band-pass filter may further include an input/output coupling circuit coupled with the resonator electrode.

In the dual-mode band-pass filter of various preferred embodiments of the present invention, therefore, the resonator electrode is disposed in the dielectric substrate, and a opening is formed in the ground electrode, whereby two resonant modes generated in the resonator electrode are coupled to achieve a dual-mode band-pass filter characteristic. This results in fewer limitations on the coupling point of the input/output coupling circuit to the resonator electrode. Moreover, the number of openings, the size of the openings, etc., can be adjusted to readily achieve dual-mode band-pass filters having various bandwidths and center frequencies.

Therefore, the design flexibility can be greatly improved, and a dual-mode band-pass filter having a desired bandwidth and center frequency can be readily achieved.

When the input/output coupling circuit and the resonator electrode are coupled across a dielectric substrate layer through the capacitance, the thickness of the dielectric substrate layer disposed between the input/output coupling circuit and the resonator electrode can be adjusted across a wide range because there are fewer limitations on the coupling position of the input/output coupling circuit. Therefore, a dual-mode band-pass filter having a desired impedance can be readily achieved.

In various preferred embodiments of the present invention, the ground electrode having the opening may be disposed on the top or rear surface of the dielectric substrate. Preferably, the ground electrode is disposed in the dielectric substrate. When the ground electrode is disposed in the dielectric substrate, a second ground electrode outside the ground electrode having the opening across a dielectric substrate layer may be disposed.

In a case where a third ground electrode is disposed on the dielectric substrate at the resonator electrode side opposite to the second ground electrode and the ground electrode having the opening, a triplate dual-mode band-pass filter capable of blocking the radiation or emission from a band-pass filter with robustness can be achieved.

In another preferred embodiment of the present invention, a duplexer includes at least one dual-mode band-pass filter according to the above-described preferred embodiments of the present invention.

In another preferred embodiment of the present invention, a radio communication apparatus includes at least one of the dual-mode band-pass filter and the duplexer according to the above-described preferred embodiments of the present invention.

Therefore, the duplexer and radio communication apparatus according to the present invention including the dual-mode band-pass filter in accordance with various preferred embodiments of the present invention can improve the design flexibility and achieve a desired frequency characteristic with ease.

Other features, elements, characteristics and advantages of the present invention will become more apparent from the following detailed description of preferred embodiments thereof with reference to the attached drawings.

### BRIEF DESCRIPTION OF THE DRAWINGS

FIG. 1A is a plan view of a dual-mode bandpass filter according to a preferred embodiment of the present invention;

FIG. 1B is a cross-sectional view of the dual-mode bandpass filter, taken along a line A-A shown in FIG. 1A;

FIG. 1C is an enlarged cross-sectional plan view of the dual-mode bandpass filter, showing a portion in which a resonator electrode is disposed;

FIG. 2A is a plan view of the dual-mode bandpass filter according to a preferred embodiment, showing the shape of an upper ground electrode;

FIG. 2B is a cross-sectional plan view of a portion in which input/output coupling circuits are disposed;

FIG. 2C is a cross-sectional plan view of the resonator electrode;

FIG. 2D is a schematic cross-sectional plan view showing the shape of a lower ground electrode;

FIG. 3 is a graph showing the frequency characteristic of the dual-mode bandpass filter according to a preferred embodiment of the present invention;

FIG. 4 is a graph showing the frequency characteristic of modifications of the dual-mode bandpass filter shown in FIGS. 1A to 1C, in which openings having different sizes are disposed in the ground electrodes;

FIG. 5 is a schematic cross-sectional plan view of another modification of the dual-mode bandpass filter shown in FIG. 1;

FIG. 6 is a graph showing the frequency characteristic of the dual-mode bandpass filter shown in FIG. 5;

FIG. 7 is a schematic cross-sectional plan view of still another modification of the dual-mode bandpass filter shown in FIG. 1; and

FIG. 8 is a schematic block diagram of a radio communication apparatus including a duplexer disposed according to another preferred embodiment of the present invention.

### DETAILED DESCRIPTION OF PREFERRED EMBODIMENTS

A dual-mode bandpass filter according to preferred embodiments of the present invention will be described with reference to a specific example taken in conjunction with of the drawings.

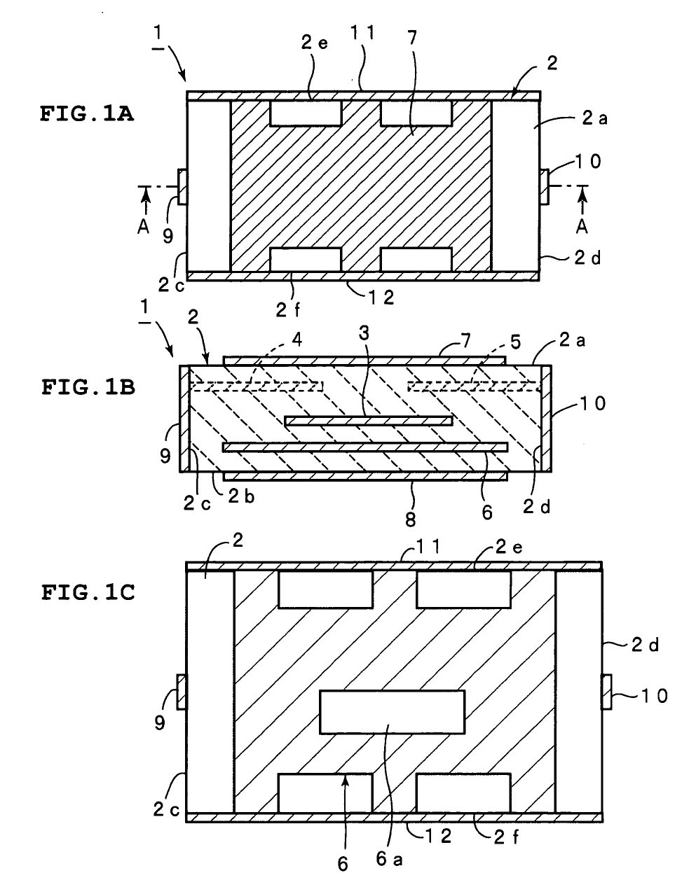

FIG. 1A is a plan view of a dual-mode bandpass filter 1 according to a preferred embodiment of the present invention, and FIG. 1B is a cross-sectional view of the dual-mode bandpass filter 1, take along a line A-A shown in FIG. 1A.

The dual-mode bandpass filter 1 preferably includes a substantially rectangular-plate dielectric substrate 2. In this preferred embodiment, the dielectric substrate 2 includes a Ba—Al—Si ceramic board with a relative dielectric constant εr=6.27 and a dielectric loss tangent tan δ=0.001. However, in this preferred embodiment and the following description, the dielectric material of the dielectric substrate 2 is not limited thereto, and the dielectric substrate 2 may be formed of a synthetic resin such as fluororesin, or an appropriate dielectric ceramic made of Ba, Al, Si, or other suitable material.

In this preferred embodiment, the size of the dielectric substrate 2 is, for example, preferably about 4.5 mm×about 3.2 mm×about 1.0 mm, but is not limited thereto.

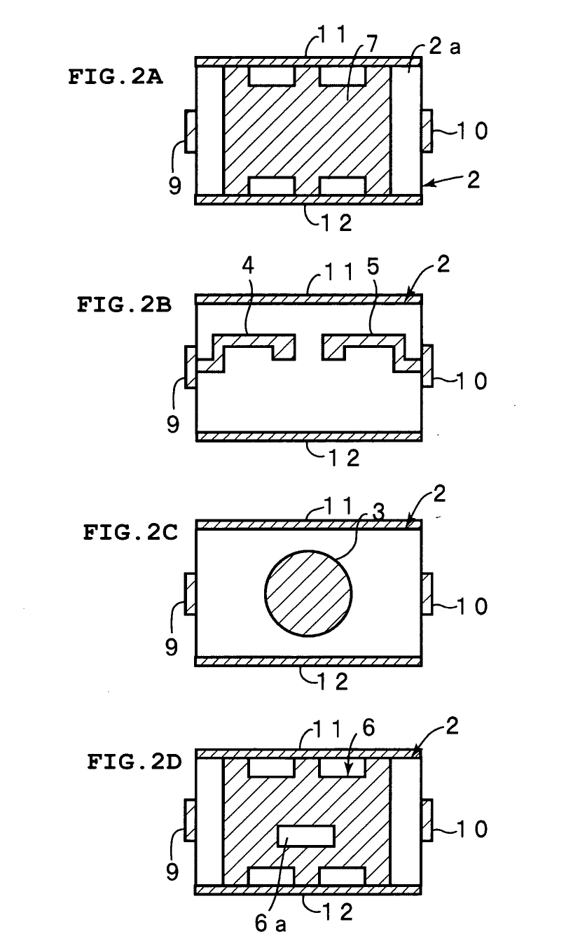

The dielectric substrate 2 has dielectric substrate layers in which a resonator electrode 3, input/output coupling circuits 4 and 5, and a ground electrode 6 are disposed. FIGS. 2B to 2D are schematic cross-sectional plan views of the layers of the input/output coupling circuits 4 and 5, the resonator electrode 3, and the ground electrode 6, respectively. The resonator electrode 3 disposed in the dielectric substrate 2 preferably has a substantially circular shape in plan view. The plan-view shape of the resonator electrode 3 is not limited to being substantially circular, and may be any shape such as a rectangle, a regular-polygon, or a triangle.

The input/output coupling circuits 4 and 5 are disposed in the layer above the resonator electrode 3. Each of the inpu/output coupling circuits 4 and 5 is arranged so as to partially face the resonator electrode 3 across the layer. In other words, the input/output coupling circuits 4 and 5 are coupled through the capacitance to the resonator electrode 3.

The ground electrode 6 is disposed in the layer beneath the resonator electrode 3. The ground electrode 6 is arranged so as to face the resonator electrode 3 across the layer. A feature of the present preferred embodiment is that the ground electrode 6 has a opening 6a at a position substantially corresponding to the resonator electrode 3. The opening 6a is used to couple two resonant modes generated in the resonator electrode 3.

The opening 6a allows for control of the resonant electric field to couple the two resonant modes generated in the resonator electrode 3, thus achieving a bandpass filter characteristic.

In this preferred embodiment, the ground electrode 6 is disposed at a height of, for example, about 0.45 mm from the bottom of the dielectric substrate 2. The resonator electrode 3 is disposed at a height of about 0.65 mm from the rear surface of the dielectric substrate 2, and is substantially circular with a radius of about 1.1 mm.

The opening 6a is preferably substantially rectangular and measures, for example, about 0.4 mm x about 1.2 mm. The opening 6a is disposed so that the longitudinal direction of the substantially rectangular opening 6a is substantially parallel to the longitudinal direction of the dielectric substrate 2.

The entirety of the opening 6a need not oppose the resonator electrode 3. As long as the resonant electric field is controlled so that the two resonant modes are coupled, a portion of the opening 6a may be deviated from the position opposing the resonator electrode 3. Moreover, as long as the opening 6a helps control the resonant electric field, the opening 6a and the resonator electrode 3 may be slightly deviated so as not to directly oppose each other.

As shown in FIGS. 1A to 1C and FIG. 2A, a second ground electrode 8 and a third ground electrode 7 are disposed on the rear surface 2b and the top surface 2a of the dielectric substrate 2, respectively. That is, the second ground electrode 8 is disposed at the ground electrode 6 side opposite to the resonator electrode 3, and the third ground electrode 7 is disposed at the resonator electrode 3 side opposite to the ground electrode 6. Thus, the resonator electrode 3, the input/output coupling circuits 4 and 5, and the ground electrode 6 are held between the ground electrodes 7 and 8.

The third ground electrode 8 and the second ground electrode 7 have a similar shape in plan view.

An input electrode 9 and an output electrode 10 are disposed on end surfaces 2c and 2d of the dielectric substrate 2, respectively, so as to extend in the thickness direction thereof. The input electrode 9 and the output electrode 10 are connected with the input/output coupling circuits 4 and 5 on the end surfaces 2c and 2d, respectively.

Connection electrodes 11 and 12 are disposed on side surfaces 2e and 2f of the dielectric substrate 2, respectively. The connection electrodes 11 and 12 electrically connect the ground electrode 6 with the second and third ground electrodes 7 and 8.

The ground electrode 6 may be electrically connected with the second and third ground electrodes 7 and 8 via a opening electrode or the like disposed in the dielectric substrate 2. For example, the ground electrode 6 may be electrically connected with the third ground electrode 8 via a opening electrode.

Each of the resonator electrode 3, the input/output coupling circuits 4 and 5, the ground electrode 6, the second and third ground electrodes 7 and 8, and the input and output electrodes 9 and 10 is preferably made of Cu in this preferred embodiment, but may be made of any other conductive material.

In the dual-mode bandpass filter 1, an input voltage is applied between one of the input/output coupling circuits 4 and 5 and the ground potential, and the output is taken from between the other of the input/output coupling circuits 4 and 5 and the ground potential. In this case, a plurality of resonant modes are generated in the resonator electrode 3. Without the opening 6a, the electric field of the resonator is confined in the ground electrode. According to this preferred embodiment, however, the electric field of the resonator is released by the opening 6a to strengthen the electric field of one of the two resonances of the dual-mode resonator. Thus, the two resonant modes generated in the resonator electrode 3 are coupled. Therefore, a bandpass filter characteristic can be achieved.

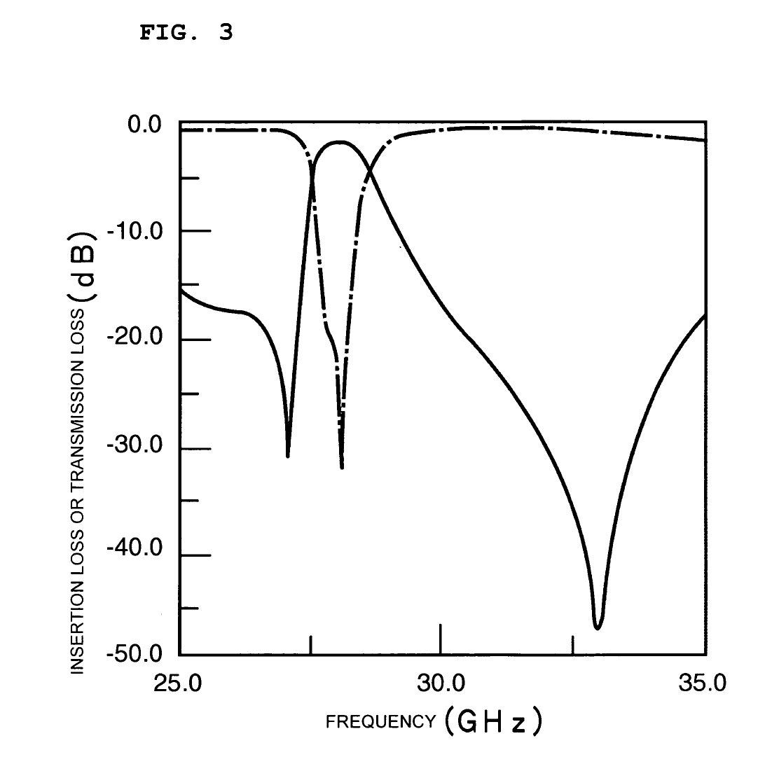

This effect will be described with reference to FIG. 3. FIG. 3 is a graph showing the frequency characteristic of the dual-mode bandpass filter 1 of this preferred embodiment. In FIG. 3, a one-dot chain line and a solid line indicate the reflection characteristic and transmission characteristic of the dual-mode bandpass filter 1, respectively. As is apparent from FIG. 3, according to this preferred embodiment, the dual-mode bandpass filter has a high frequency characteristic in the 28-GHz band. This is because distribution of the resonant electric field of the resonator electrode 3 is partially strengthened due to the opening 6a to couple the two resonant modes.

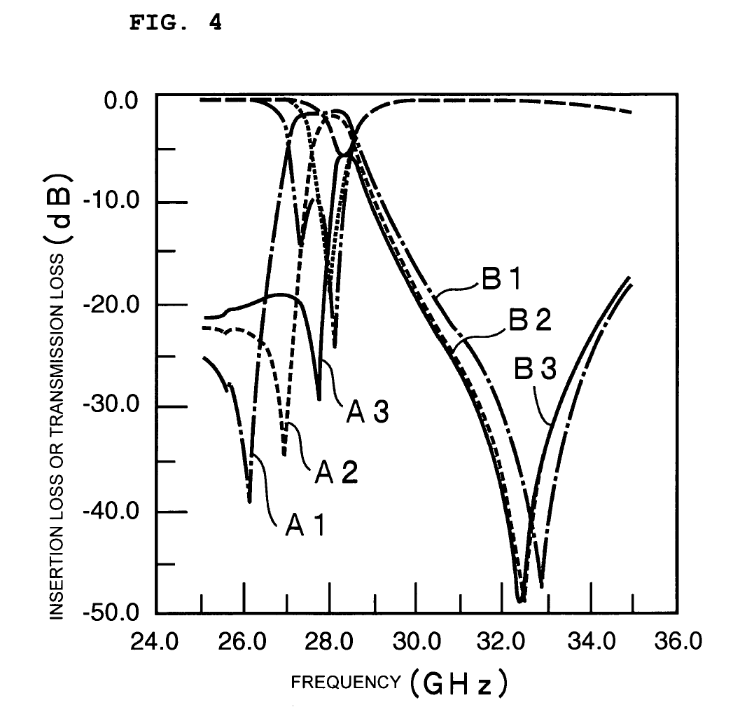

In the dual-mode bandpass filter 1 of this preferred embodiment, as described above, the opening 6a is disposed in the ground electrode 6, thus achieving a dual-mode bandpass filter. There is no particular limitation on the coupling position of the input/output coupling circuits 4 and 5 and the shape of the resonator electrode 3, thus significantly improving design flexibility of the dual-mode bandpass filter 1. Moreover, the size and position of the opening 6a can be adjusted to readily achieve dual-mode bandpass filters having different bandwidths and frequency characteristics. This effect will be described with reference to FIG. 4.

FIG. 4 is a graph showing the frequency characteristic of dual-mode bandpass filters having openings 6a disposed in the center of the dielectric substrate 2, in plan view, with approximate dimensions 0.4 mm×0.4 mm, 0.4 mm×0.6 mm, and 0.4 mm×0.8 mm, respectively.

In FIG. 4, lines A1 through A3 and lines B1 through B3 indicate the reflection characteristic and transmission characteristic of the dual-mode bandpass filters, respectively.

The characteristics of the dual-mode bandpass filter having the 0.4 mm×0.4 mm opening 6a are indicated by the solid lines A3 and B3, the characteristics of the dual-mode bandpass filter having the 0.4 mm×0.6 mm opening 6a are indicated by the broken lines A2 and B2, and the characteristics of the dual-mode bandpass filter having the 0.4 mm×0.8 mm opening 6a are indicated by the one-dot chain lines A1 and B1.

As is apparent from FIG. 4, the larger the opening 6a, the wider the bandwidth.

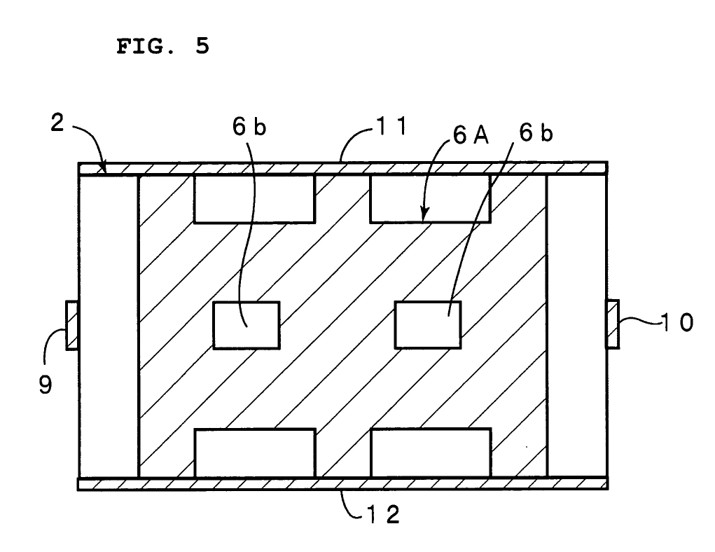

FIG. 5 is a schematic cross-sectional plan view of a modification of the dual-mode bandpass filter of the above-described preferred embodiment. The dual-mode bandpass filter shown in FIG. 5 has a ground electrode 6A. The dual-mode bandpass filter of this modification has a similar structure to that of the dual-mode bandpass filter 1, except that a plurality of openings 6b are disposed in the ground electrode 6A at a position substantially opposing the resonator electrode 3. Each opening 6b preferably has a substantially rectangular shape with dimensions of about 0.4 mm×about 0.6 mm, and,the openings 6b are symmetrically arranged with respect to the center of the dielectric substrate 2. The center-to-center distance between the openings 6b is preferably about 1.1 mm, for example.

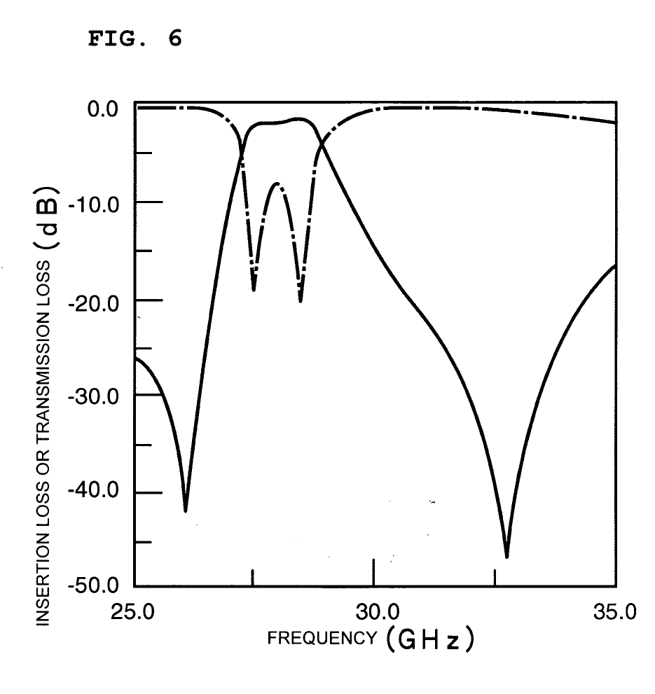

The frequency characteristic of the dual-mode bandpass filter of this modification having the ground electrode 6A different from the ground electrode 6 of the dual-mode bandpass filter 1 is shown in FIG. 6. In FIG. 6, a one-dot chain line and a solid line indicate the reflection characteristic and transmission characteristic of the dual-mode bandpass filter of this modification, respectively.

As is apparent from FIG. 6, the dual-mode bandpass filter having the plurality of openings 6b is able to achieve a bandpass-filter frequency characteristic, like the dual-mode bandpass filter 1.

In preferred embodiments of the present invention, therefore, a ground electrode may have one or more than one opening.

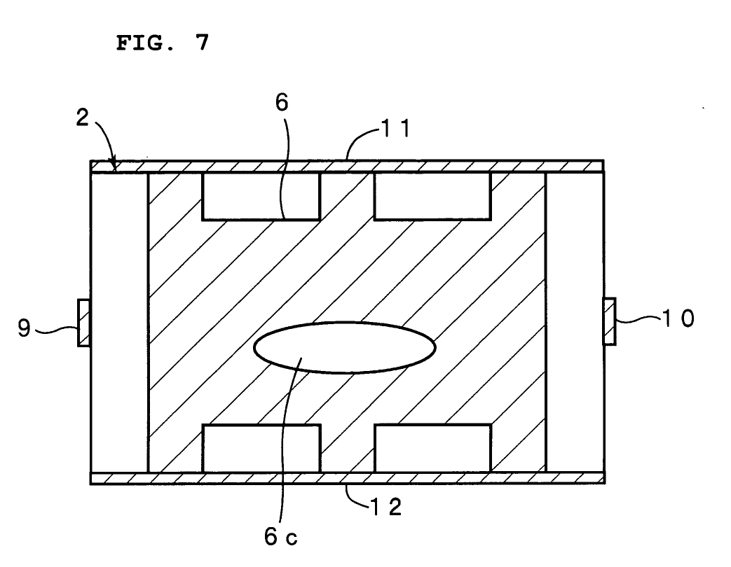

FIG. 7 is a schematic cross-sectional plan view of a opening 6c as a modification of the opening 6a of the dual-mode bandpass filter 1. As shown in FIG. 7, the opening 6c may be elliptical and disposed in the ground electrode 6 at a position substantially opposing the resonator electrode 3. In the present invention, therefore, the shape of the opening is not limited to being substantially rectangular, and the opening may be of any shape such as elliptical, circular, or rhombic.

Although the dual-mode bandpass filter 1 shown in FIGS. 1A to 1C includes the second and third ground electrodes 8 and 7, the ground electrodes 7 and 8 are not essential. However, it is preferable that the ground electrode 6 having the opening 6a oppose the ground electrode 8 therebeneath across a dielectric substrate layer in order to ensure coupling between two resonant modes.

The ground electrodes 7 and 8 are not necessarily disposed on the top surface 2a and the rear surface 2b of the dielectric substrate 2, respectively, and may be embedded in the dielectric substrate 2.

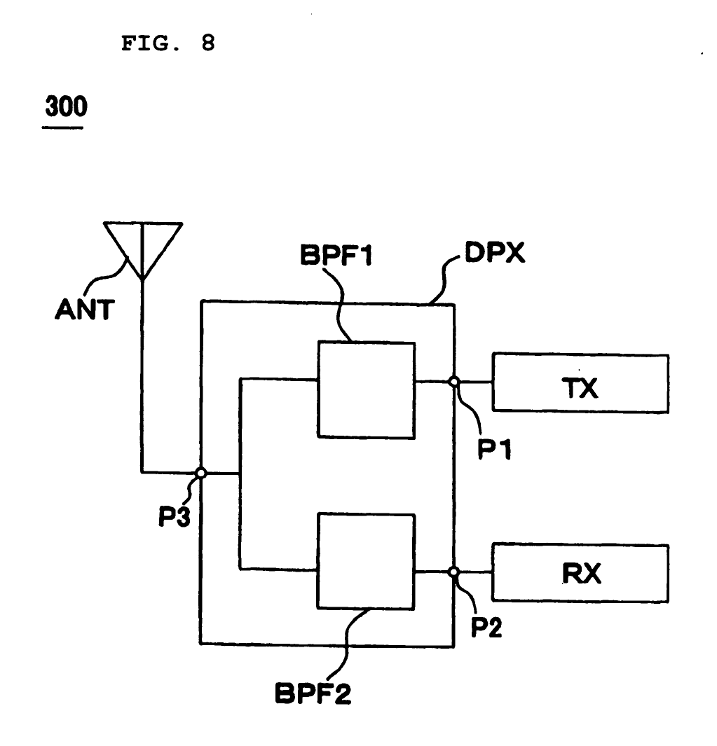

A duplexer using the dual-mode bandpass filter in accordance with another preferred embodiment of the present invention and a radio communication apparatus according to another preferred embodiment of the present invention will be described with reference to FIG. 8.

FIG. 8 is a block diagram showing the main portion of a radio communication apparatus 300 including a duplexer DPX that uses the above-described dual-mode bandpass filter.

The duplexer DPX of this preferred embodiment includes first and second bandpass filters BPF1 and BPF2, each of which is defined by the dual-mode bandpass filter in accordance with the above-described preferred embodiments of the present invention. The first and second bandpass filters BPF1 and BPF2 have first ends connected with first and second ports P1 and P2 of the duplexer DPX, respectively. The first and second bandpass filters BPF1 and BPF2 have second ends commonly connected with a third port P3 of the duplexer DPX.

The first port P1 is connected to a transmitter TX, and the second port P2 is connected to a receiver RX. The third port P3 of the duplexer DPX is connected to an antenna ANT.

The duplexer of this preferred embodiment includes the first and second bandpass filters BPF1 and BPF2 each defined by the dual-mode bandpass filter in accordance with the above-described preferred embodiments of the present invention, thus readily achieving a desired bandwidth with high flexibility in design. The radio communication apparatus 300 includes the duplexer DPX, thus making it easy to improve the communication quality.

The present invention is not limited to each of the above-described preferred embodiments, and various modifications are possible within the range described in the claims. An embodiment obtained by appropriately combining technical features disclosed in each of the different preferred embodiments is included in the technical scope of the present invention.

What is claimed is:

1. A dual-mode bandpass filter comprising:
a dielectric substrate;
a resonator electrode disposed at a certain height in said dielectric substrate; and
a ground electrode disposed at a different height in said dielectric substrate from said resonator electrode so as to oppose said resonator electrode; wherein
said ground electrode includes at least one opening, whereby a resonant electric field of said resonator electrode is controlled to couple two resonant modes generated in said resonator electrode.

2. A dual-mode bandpass filter according to claim 1, wherein the opening is disposed at a position substantially opposing said resonator electrode.

3. A dual-mode bandpass filter according to claim 1, wherein said ground electrode is embedded in said dielectric substrate.

4. A dual-mode bandpass filter according to claim 3, further comprising:
a second ground electrode disposed on said dielectric substrate at the ground electrode side opposite to said resonator electrode; and
a third ground electrode disposed on said dielectric substrate at the resonator electrode side opposite to said ground electrode.

5. A dual-mode bandpass filter according to claim 4, wherein the second ground electrode is disposed on the top surface of said dielectric substrate, and the third ground electrode is disposed on the rear surface of said dielectric substrate.

6. A dual-mode bandpass filter according to claim 1, wherein said ground electrode includes a plurality of openings.

7. A dual-mode bandpass filter according to claim 1, wherein each opening has one of a substantially rectangular shape, a substantially circular shape, a substantially rhombic shape, and a substantially polygonal shape, in plan view.

8. A dual-mode bandpass filter according to claim 1, further comprising an input/output coupling circuit coupled with said resonator electrode.

9. A duplexer comprising at least one dual-mode bandpass filter according to claim 1.

10. A radio communication apparatus comprising the dual-mode bandpass filter according to claim 1.

11. A radio communication apparatus comprising the duplexer according to claim 9.
